(19) United States
(12) Patent Application Publication
(10) Pub. No.: US 2007/0011396 A1
(43) Pub. Date: Jan. 11, 2007

(54) Method and apparatus for bandwidth efficient and bounded latency packet buffering

(75) Inventors: Kanwar Jit Singh, Bangalore (IN); Dhiraj Kumar, Morristown, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/172,114

(22) Filed: Jun. 30, 2005

(51) Int. Cl. G06F 13/28

(52) U.S. Cl. 711/105

(57) ABSTRACT

A system and method for buffering data packets in a data network device having a DRAM buffer are presented. When writing packets, the buffering system separates available memory channels into two groups corresponding to ingress and egress data. Based on the source of the data packets, data pages from the data packets are assigned to channels from either the ingress or egress group. Non-conflicting sets of addresses, called cachelines, are requested on each memory channel, and the data pages are evenly distributed over the assigned channels before being mapped to a cacheline. The number of read transactions currently being monitored by the system is controlled in order to reduce random packet read conflicts. Additionally, write and read transactions are grouped by an arbitration unit prior to being sent to the DRAM controller.

### FIELD

The present invention relates to the field of switches and routers for network systems. More specifically, the present invention relates to switches and routers that have improved memory efficiency and speed.

### BACKGROUND

Physical network connections in modern data networks comprise ever-increasing capacities for the amount of data and speed for which they can be utilized. In data network switches and routers the amount of time required to properly route incoming data packets to the proper outgoing port, or the switching latency, is non-zero. Because this switching latency is non-zero, it is necessary for these switches and routers to have the capability to temporarily store packet data while the proper routing of the packet is being performed. As the capacity and speed of networks increases, the amount of buffering space required also increases. Given the speed and capacity of data network technology today, local caches and integrated buffers generally provide insufficient space to temporarily store packet data during the switching or routing process. As a result, the data must be buffered off chip in external memory devices such as dynamic random access memory (DRAM) modules.

A typical high-capacity switch or router generally consists of multiple packet processing cards (PPC) each of which may serve multiple external network ports. At any given moment, a PPC may have packet data from the external network arriving on several of these ports; this data may be considered ingress packet data. As described above, this packet data may require a certain amount of time to be processed, and in the interim the packet data must be buffered until it is ready to be sent to an output port, possibly to another PPC over an internal switch fabric. Similarly, each card may simultaneously be receiving data from other processing cards. This incoming data from the internal switch fabric, or egress traffic, may also need to be buffered until it is ready to be sent back out over the network. Buffering egress traffic also permits the system to fulfill Quality-of-Service (QoS) requirements in the case of a blocked or failed external network transmission. In general, a PPC in a router or packet switch receives ingress traffic from an external network that it then processes and then sends out onto an internal switch fabric, and receives egress traffic from the internal switch fabric that it processes and then places onto the external network.

FIG. 1 illustrates the architecture of a general PPC, according to the prior art. A network port interface 102 may provide a physical link between the external network and the router buffering system. Data packets received from the external network may be paged by the port interface 102 into manageable data segments that can be stored by the ingress buffer manager 104. The network port interface may append one or more signature pages to the start of the data packet; these signature pages may aid in the processing of the data packet pages by the ingress and egress buffer managers, as well as facilitate the switching of the packet pages over the internal device switch fabric. Additionally, the port interface module 102 may perform some processing on the header pages of the data packet, including the modification of security and transport protocol variables; alternatively, this processing may be performed by the ingress buffer manager 104. After the data packet has been paged and modified by the port interface 102, it may be sent to an ingress buffer manager 104. The ingress buffer manager may store the data packet pages in an external buffer memory 110 until an ingress traffic manager 106 has scheduled the packet to be sent to the internal switch fabric 112. When the packet is scheduled by the ingress traffic manager, it is read out of the external buffer memory 110 and may either be streamed directly to the switch fabric 112 or be temporarily staged in an exit queue prior to being placed on the switch fabric 112; in either case, the packet suffers from read latency that may result in throughput loss in the first case or the need for increased buffering in the latter. After a packet is sent out to the internal switch fabric, it may be received by the egress buffer manager of a PPC, possibly the same PPC that placed the data packet on the internal switch fabric. The egress buffer manager may store the data packet pages within the buffer memory 110 until an egress traffic manager 118 has scheduled the packet to be sent to the port interface module 102 and out to the external network. The port interface module 102 may then remove any signature bits and perform any additional header processing on the packet prior before modulating the packet data onto the external network.

In this general packet processing system, both the ingress buffer manager and egress buffer manager utilize the same external buffer memory as a temporary storage for data packets. Since each ingress and egress data packet must be buffered in the external memory module, the ability to quickly access the external buffer memory becomes an important factor in determining the overall switching speed of the router. This access includes both writing data to the external memory (buffering) and reading data from the external buffer memory. Both of these processes are related in several ways, in the manner that a modification to the method for writing data will invariably impact the reading process, and also in the manner that both must access the external memory using the limited bandwidth provided by one or more memory channels. Furthermore, the reading process is closely related to the scheduling process, in that the greater the read latency, the larger the amount of staging that is required by the scheduling process. Therefore any modifications to the write process, the read process, or the scheduling process require the consideration of the effect on the efficiency of the other processes.

The ability to quickly access the external buffer memory is dependent on both the bandwidth and the efficiency of the one or more external buffer memory channels. In general the effective bandwidth of the memory channels must be sufficient to handle the reading and writing activity of both the ingress and egress buffer managers. In a system that receives packet data at an average rate of 10 Gb/s, the required effective memory bandwidth for each buffer manager may be twice this amount (to account for writing at 10 Gb/s and simultaneously reading at 10 Gb/s), giving a total required effective memory bandwidth of four times this amount (since there are two buffer managers per PPC), or 40 Gb/s. When multiple PPCs need to send data to the same destination PPC, there is contention for the destination port in the switching fabric. Furthermore, in order to guarantee access to the fabric, the switch ports run faster (i.e. there is a speed-up towards the switch fabric). This is done to achieve non-blocking switching at the advertised throughput. As a result the requirement for bandwidth increases beyond 40 Gb/s. For a 50% speed up that requirement is equal to 50 Gb/s (=2*[10+15]).

The total effective bandwidth of a memory module is the product of the number of memory channels, the physical bandwidth of each channel, and the channel efficiency. As a result, a system may increase the total effective bandwidth by increasing the overall number of memory channels, utilizing higher bandwidth channels or increasing the efficiency of the channels. Increasing the overall number of memory channel may generally require additional circuitry and more resources, both on and off the chip, thereby increasing the area requirements of the chip and its associated production costs. However, utilizing higher bandwidth channels may require the use of more expensive memory architectures in the best case, and may require technology that is not yet available in the worst case.

Channel efficiency is affected by several factors, including both the average number of conflicts experienced by the memory system, and the worst-case latency of a memory transaction. A general DRAM buffer may comprise multiple devices, each having multiple banks; in turn each of these banks may receive input via separate row and column control buses and separate read and write data buses. This division of control and access buses allows greater flexibility in reading multiple memory locations in parallel, especially in “open”0 page mode, where a memory bank is not automatically closed after it is accessed; this policy is different from a “closed” page mode where the bank is closed after every access. In a memory system that operates under an open page paradigm, a conflict may be considered as any sequence of memory accesses that forces a loss of data cycles on the memory channels. These lost data cycles translate directly into a loss of memory bandwidth. Some access patterns that can lead to lost cycles are: access to the bank adjacent to the current activated bank, access to the same bank as the current activated bank but on a different device, access to a different row than the current accessed row on the current activated bank, and a read access followed by a write access on the same channel.

The memory channel efficiency may also have the effect on the read latency of the system. Generally, the external DRAM is divided into fixed size pages for ease of memory management, page allocation and page release. Usually each page is equal to a row in the DRAM. The size of the external memory page may be designed as a compromise between bandwidth utilization efficiency and space utilization efficiency. As stated above, incoming packets, which may be of variable length in internet protocol (IP) routers, are usually divided into fixed-size pages based on the external memory page size. With the packets divided into multiple pages, and with access to the external memory being shared between data packets received over multiple ports, the pages of a given packet cannot be written to contiguous page locations in memory. As a result the pages of each data packet may be linked as a data structure, which may be a single-linked list. This commonly used data structure may be realized by storing a link pointer with a data page in memory, where the link pointer refers to the memory location of the subsequent data page in the data packet. Because the information used to link segments in a single-linked list is stored with the data in memory, the reading of a packet is an iterative process. This process requires reading one page at a time from the memory, deciphering the link pointer stored with the page, and then retrieving the next page in the packet at the specified link pointer location. As memory channel efficiency decreases (for example, due to increased memory conflicts) the latency associated with retrieving a single page may be substantially increased, resulting in ever-larger total packet read latencies. Larger the packet read latencies place increased demands on both the output packet buffer sizes and the read scheduling circuitry complexity. Subsequently, the overall cost of producing and manufacturing the system may be greatly increased.

In view of the above limitations of general routers and switches, it would be desirable to improve the DRAM channel efficiency while also optimizing the limit on packet read latency. It would also be desirable to optimize memory bandwidth utilization in order to permit the buffering system of the router or switch to obtain substantially higher throughput and capacity. This would also help to avoid the need for larger on-chip output buffer memories to accommodate high total packet read latency. By providing an optimized scheduling scheme that avoids scheduling conflicts it may be possible to increase memory channel efficiency and mitigate the effects associated with a high DRAM read latency.

### BRIEF DESCRIPTION OF THE DRAWINGS

Exemplary embodiments of the invention are described below in conjunction with the appended figures, wherein like reference numerals refer to like elements in the various figures, and wherein:

FIG. 1 is a schematic of a packet processing card for a network device, according to the prior art;

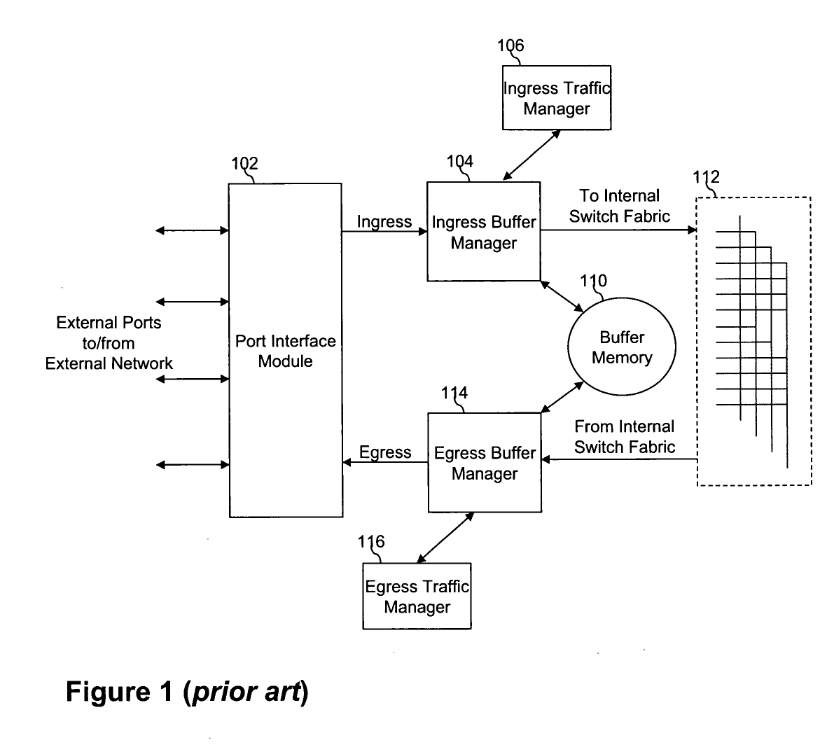

FIG. 2 is a schematic of a packet processing system for a network device having, according to an embodiment;

FIG. 3 is a detailed schematic of a portion of a packet processing system dedicated to writing incoming packets to an external buffer memory, according to an embodiment;

FIG. 4 is a flow diagram illustrating the process of buffering of data packets by the write administrator, according to an exemplary embodiment;

FIG. 5 is a detailed schematic of a portion of a packet processing system dedicated to reading incoming packets from an external buffer memory, according to an embodiment;

FIG. 6 is a flow diagram illustrating the retrieval of data packets from buffer memory by the read administrator, according to an exemplary embodiment;

FIG. 7 is a detailed schematic of a portion of a packet processing system dedicated to writing incoming packets to an external buffer memory, according to an embodiment; and

FIG. 8 is a flow diagram illustrating the arbitration of transactions from the read queues and write queues by the arbitration unit, according to an exemplary embodiment.

### DETAILED DESCRIPTION

1. System Overview

The packet buffering system presented provides a system that increases the efficiency of the external dynamic random access memory (DRAM) buffer by reducing the probability of memory transaction conflicts and avoiding extensive latency issues associated with read transactions. For read transaction issues, the system implements a scheme that controls the number of data packet read requests scheduled in the system at any given time. For write transaction issues, the system implements a policy to use non-conflicting addresses to both minimize memory conflicts and increase the predictability of the open page memory system. Additionally, the system provides several general methods to mitigate the effects associated with random read transactions interfering with write transactions, including: implementing a write policy to reduce the number of memory banks being used for write transactions at any given time to reduce write-versus-read conflicts; implementing an arbitration policy to schedule read and write transactions in separate groups to reduce turnaround loss that may be caused by a write transaction followed by a read transaction; and implementing a write policy that evenly distributes written data pages amongst multiple channels in order to further increase parallelism and predictability in the system, and to increase the effective bandwidth of all channels.

As a result, the current invention seeks to increase efficiency of memory systems by several distinct methods. Where the buffering system manages both ingress and egress traffic, the system processes the ingress and egress traffic separately in order to increase the predictability of the system. The system also utilizes an algorithm to determine the sequence of bank assignments or write transactions to minimize the conflicts with the scheduled reads, and to minimize the probability of the writes and reads being “lock-stepped” in the choice of the banks they access. In addition, the system seeks to increase the fairness of the system by (i) distributing the total data transfer evenly across all available memory channels, and (ii) distributing the data pages of a given packet evenly across all available memory channels as well, thereby providing a level of effective bandwidth that is substantially equal across all memory channels; this fairness extends beyond simply distributing pages evenly, and seeks to evenly distribute the actual amount of data handled by each channel. The distribution of data pages across multiple memory channels permits the read bandwidth to be insensitive to where the packets are written.

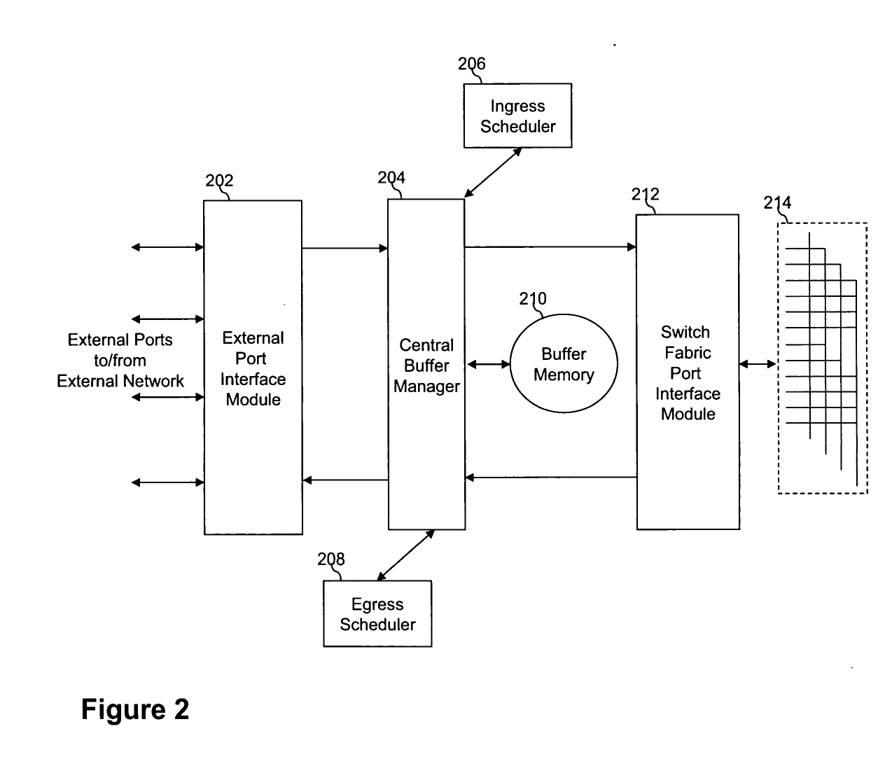

FIG. 2 shows the buffering system according to an exemplary embodiment. The system may have one or more ingress ports 202 that may receive data packets from an external data network. Additionally, the system may have one or more egress ports 212 that may receive packets from and send packets to an internal switch network 214. Data packets that are received on any of the ports are buffered in memory 210 prior to either being sent out to the network or being forwarded to another processing card in the network device. The buffer memory transactions may substantially comprise either writes or reads.

The system services write transactions by receiving data packet pages from the ingress and egress port interfaces 202, 212. Both interfaces send the data pages to a write administrator in a central buffer manager 204. The write administrator requests non-conflicting physical addresses in the DRAM buffer memory 210 and then maps the data pages to these addresses, using a write policy that distributes the data pages over a group of memory channels. Write transactions for the data pages are then sent by the write administrator to a series of write queues, where they await servicing by an arbitrator before being sent to the DRAM controller.

The system services read transactions by receiving packet-read requests from ingress and egress schedulers 206, 208. These packet-read requests may comprise such information as a pointer to the first data page of the packet in the DRAM buffer, and the total length of data in the packet. The packet-read requests are conditionally accepted by a read administrator in the central buffer manager 204, depending on the number of read requests currently being processed by the system. The read administrator then sends the packet-read requests to a series of read queues, where they await servicing by an arbitrator before being sent to the DRAM controller 312. After a read request has been serviced by the DRAM controller and the specific data page has been received, the pointer to a subsequent data page in the data packet is interpreted and a request for the subsequent data page is inserted into the series of read queues.

Write and read transactions from the write and read queues are then grouped by an arbitrator, depending on a given grouping size. The arbitrator alternates between issuing groups of write and read requests which are subsequently handled by the DRAM controller. When handling a read transaction, the DRAM controller generally returns the selected data specified by the read transaction, where this data generally includes a data page along with one or more link pointers used for creating a data structure.

2. Data Packet Buffering

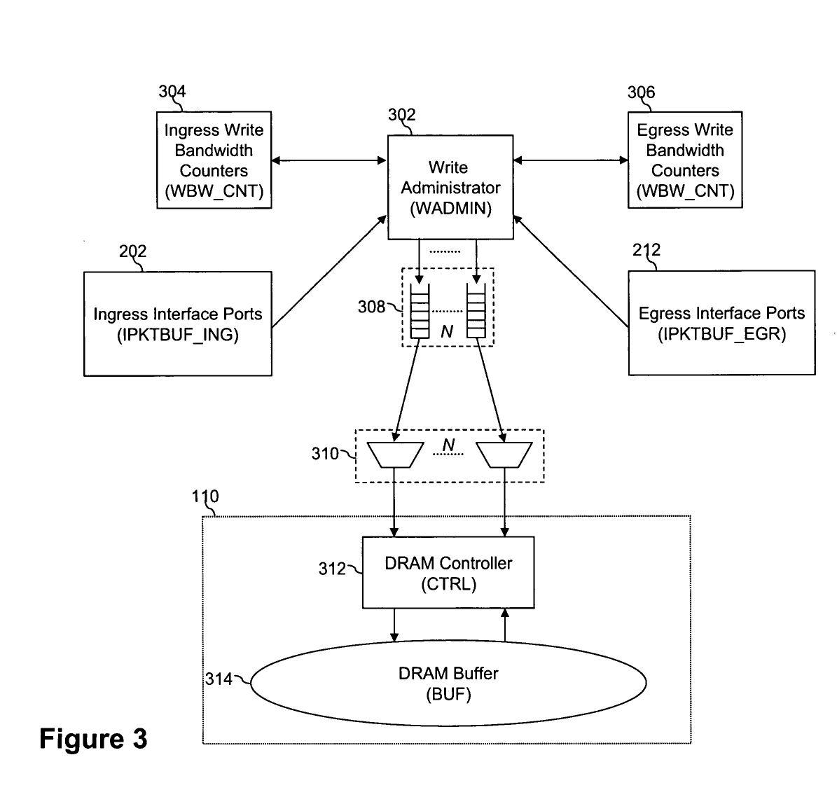

FIG. 3 shows a portion of the packet processing system dedicated to writing incoming packets to an external buffer memory. Data packets may arrive on either the ingress ports 202 (IPKTBUF_ING) or egress ports 212 (IPKTBUF_EGR), with the ingress ports partitioning data packets into fixed-sized pages, while the data packets received by the egress ports may have been previously paged. Generally the size of the pages is selected so as to facilitate storage of the pages in the DRAM. As a result, the data packet partition size may be equal to or less than the size of the DRAM page size. In the case that the data packet partition size is smaller than the size of the DRAM page size, the data packet partition size may be chosen to allow the addition of one or more pointers to the data packet page data, thereby allowing the data packet pages to be formed into a single-linked list data structure. Additionally, control values may also be appended to the data page may; these values may comprise the page type (packet start, packet end, packet continuation) and the length of the data page. For example, if the DRAM page size is 64 bytes, 60 bytes may be reserved for data while 4 bytes may be reserved for a memory pointer and associated control values.

The paged ingress and egress data packets from the incoming ingress and egress ports may then be sent to a write administrator 302 (WADMIN) that maps the data packets to physical DRAM locations. The write administrator 302 may write ingress data pages to the DRAM buffer 110 using one group of memory channels (ingress memory channels), and may use a second separate group of memory channels (egress memory channels) for writing egress data pages. The ingress memory channels and egress memory channels are generally mutually exclusive, with the ingress memory channels only handling ingress data packet traffic and the egress memory channels only handling egress data packet traffic. The DRAM channels may be designated as ingress memory channels and egress memory channels by the write administrator 302 or other module. Additionally, the designation of DRAM channels to each group may be dynamically modified based on several factors, including trends regarding the proportion of data traffic processed on ingress versus egress ports. For example, in a system with four DRAM channels, originally two may be designated as ingress channels and two may be designated as egress channels; however, if it is determined that the egress channels are relatively under-utilized while the ingress channels are suffering from large queuing delays then the system may re-designate three channels as ingress channels and one channel as an egress channel.

When mapping the data pages to physical memory locations, the write administrator 302 may schedule and map the data page writes so as to minimize write-versus-write conflicts. In order to accomplish this optimization, the write administrator 302 may request a set of non-conflicting memory address groups, or cachelines, on each channel in the memory specific channel group, wherein the channel group corresponds to either the ingress ports or the egress ports. The cacheline is essentially a set of memory page addresses that access the same row of the DRAM such that there is no penalty when moving from one page to another page within the cacheline. In one embodiment, each of the addresses in the cacheline may correspond to an entire row on a given DRAM device and bank. The set of cachelines may be used until all addresses from the set of cachelines are assigned to corresponding data pages, at which point a new set of cachelines for each of the channels in the specific group may be requested.

When a new set of cachelines is required, each cacheline may be selected based upon the last selected cacheline (the “current” cacheline). In general, cachelines are selected according to the following rules: the new cacheline will have a bank that is equal to the current cacheline bank incremented by a value greater than or equal to three, while maintaining the same device and row as the current cacheline; once all banks on a device have been selected, the new cacheline will be selected on the next device in a round robin manner; once all banks on all devices have been assigned to cachelines, the row is incremented and the process repeats. Specifically, in one embodiment a newly selected cacheline is selected by choosing the new memory bank number to be equal to the current bank number incremented by a prime number greater than or equal to three modulus the total number of banks in the device, until all data banks corresponding to a given device and row have been selected; after all data banks on a device have been utilized, the write administrator may then progress to the next DRAM device in a round robin fashion; once all data banks on all devices corresponding to a given row have been selected, the write administrator may then increment the row for the next cacheline request. In the above method, each device, bank, and row is represented by a value or number, in accordance with general memory terminology; for example, a memory device having eight memory banks will have the banks numbered 0 through 7; in this memory device, if the prime number used to select a new bank is 5, and the current bank number is 6, then the new bank number will be 11 modulus 8, or 3. Additionally, once all banks in a device have been selected, the bank for the next cacheline may be chosen by using the same prime number but reversing the direction of the modulus, thereby further increasing randomness and preventing read and write transactions from becoming lock-stepped. Alternatively, a different prime number may be utilized each time a new bank is selected, or when the direction of the modulus is reversed. The intent of using a prime number in the selection of a new bank is to have a periodic pattern that results in each bank being selected per round; however, any number that accomplishes this result may be used. By implementing a write policy that reduces the number of banks being used for writes at any given time, the system may reduce the number of write-versus-read conflicts.

The write administrator 302 may also implement a write policy to assign pages of a given data packet as equally as possible to the channels of a given group, where the group is the set of memory channels assigned to either the ingress ports or the egress ports. In order to implement this policy, the write administrator 302 may employ several bandwidth counters 304, 306 that keep track of the number of bytes written to the external buffer using each memory channel in a group; these counters may then be used to determine the memory channel least utilized for writes at any given time. The number of bytes are tracked as opposed to the number of pages, as the last page in a data packet may contain less information than provided by the standard data page size; therefore if a channel is constantly assigned the last pages of data packets, the bandwidth utilization of the channel will be substantially lower than another channel that receives the same amount of full data pages. There may be N write bandwidth counters (WBW_CNT), where N is the number of memory channels in the group assigned to the interface to which the port belongs. For each data page that is written to a given memory channel, the counter associated with the channel may be incremented by the number of bytes in the data page. The least-used memory channel in a group may be determined by finding the memory channel associated with the counter having the lowest stored value. When an end-of-packet (EOP) data page is encountered, the subsequent start-of-packet (SOP) data page of the next data packet may then be assigned to the least-used channel in the group. Once the SOP data page of a data packet has been assigned to a channel, the write administrator 302 may then assign the following corresponding data pages received on the port to the other memory channels in the group using a round robin process. This distributed assignment of packets may continue until an EOP data page is encountered, at which point the next page (an SOP) is again assigned to the least-used channel. The data pages are then sent to the write queue 308 corresponding to their assigned memory channel. Each write queue may belong to an ingress or egress memory channel, and as a result the write queues may be similarly separated into ingress write queues and egress write queues. In this designation, each ingress write queue handles write transactions for a single ingress memory channel and each egress write queue handles write transactions for a single egress memory channel.

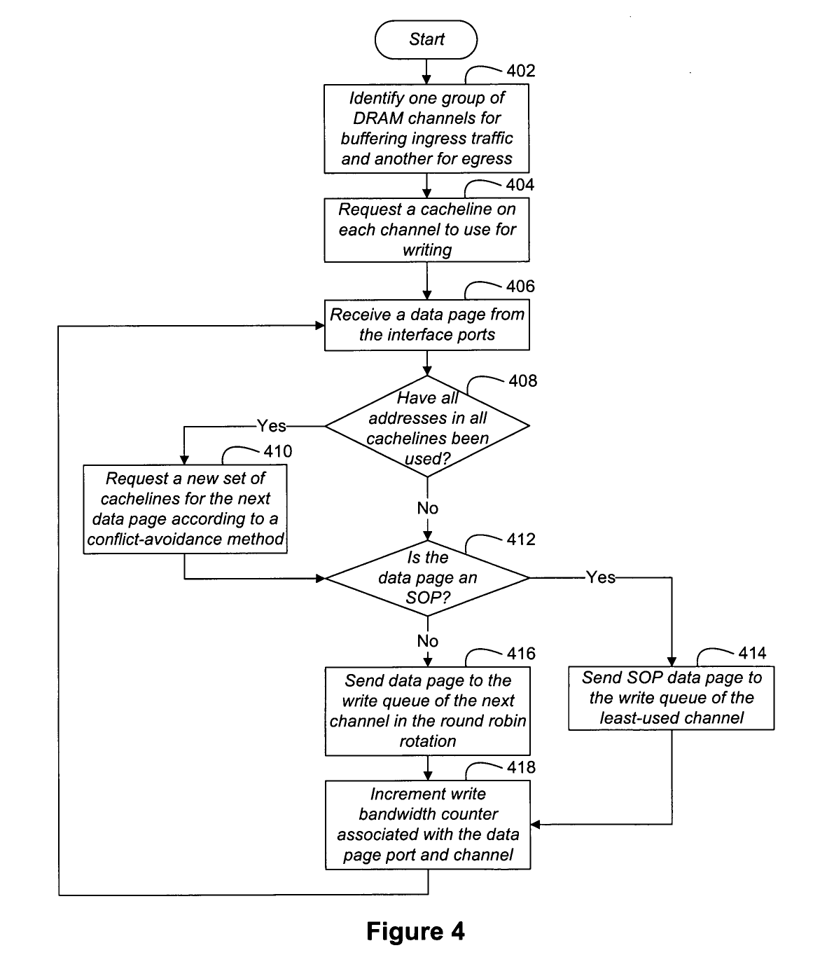

FIG. 4 illustrates a process used by the write administrator 302 when writing data pages to the DRAM buffer 110, according to one embodiment of the invention. In the initial setup, the write administrator determines which memory channels will be used exclusively for egress traffic and which will be used exclusively for ingress traffic 402. The write administrator then requests a set of cachelines containing locations where data pages may be written sequentially, with one cacheline being requested for each channel in the egress and ingress groups 404. Data pages are then retrieved from the ingress and egress port interfaces 406. The system then determines if there are any available addresses in any of the cachelines of the current set of cachelines 408. If all addresses of the cachelines in the set of cachelines have been assigned, a new set of cachelines is requested 410. Each new cacheline in the newly requested set of cachelines may be chosen using the method described above, using relatively large increments in selecting banks, performing a round robin on DRAM devices, and finally incrementing the row used for the cacheline. The pages are examined to determine their originating port and type, where the type may be an SOP, EOP, or neither. If the data page is an SOP page 412 then the page is assigned to the least-used channel as determined by the bandwidth counters associated with the originating port of the data page 414. If the data page is not an SOP 412, then the data page is assigned to the next address location in the cacheline associated with the next memory channel in the round robin rotation 416. After a data page has been sent to a read queue, the write bandwidth counter that corresponds to the destination memory channel is incremented 418. The next data page is then retrieved from the incoming port interfaces and the process repeats.

3. Buffered Data Packet Reading

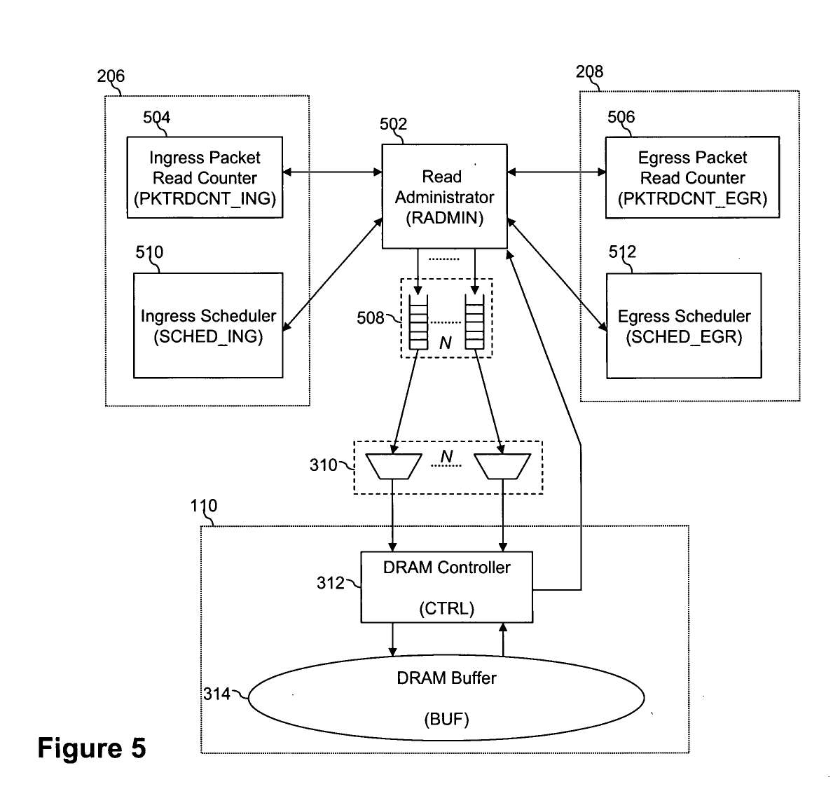

FIG. 5 shows a portion of the packet processing system dedicated to reading data packets from an external buffer memory. After a data packet has been buffered and its destination port has been determined, the individual data pages composing the data packet may then be read out of memory. The data packets may be scheduled to be read out of the buffer memory by an ingress scheduler 510 (SCHED_ING) and an egress scheduler 512 (SCHED_EGR). When a packet is required from the buffer memory, the associated scheduler unit may provide a read administrator 502 with a packet read request. This request may comprise a memory pointer for the SOP data page (a header pointer) along with the total length of the data packet. The read administrator 502 may or may not accept the data packet, depending on the current number of outstanding read requests waiting to be serviced by the DRAM controller 312.

In order to determine the number of packet read requests awaiting service by the DRAM controller 312, the read administrator may maintain two packet read counters, one for ingress 504 (PKTRDCNT_ING) and one for egress 506 (PKTRDCTN_EGR) ports. When a packet read request is accepted by the read administrator 502, the appropriate read counter is incremented, where the appropriate read counter is based on whether the packer arrived on an ingress or egress port. Once a packet read request has been completely serviced (all data pages associated with the data packet have been read out of the DRAM buffer) the appropriate read counter is decremented. With these counters, the read administrator 502 may be configured to stop accepting packet read requests from the scheduler units 510, 512 when the associated packet counter rises beyond a certain threshold. The threshold value may be a constant value, or it may be a dynamically configurable value that can be set by the user. Additionally, each packet read counter may have a different threshold value.

When the read administrator 502 accepts a packet read request, it may store the packet length and place the head pointer in the read queue for the memory channel on which the pointer location resides. The head pointer may pass through an arbitration module and then pass to the DRAM controller 312, which may then retrieve the SOP data page at the memory location designated by the head pointer. The link pointer to the next data page in the data packet sequence may be extracted from the SOP data page, and this link pointer may then be queued in the read queue 508 for the memory channel on which the link pointer location resides. This process of packet retrieval and pointer interpretation continues until the entire data packet has been read out of memory. The read administrator 502 may determine that a packet is completely read out of memory when the number of bytes of data recovered from read data pages substantially equals the length of the packet provided in the packet read request, or when an EOP data page for the corresponding data packet is retrieved.

As discussed above, the queuing delay suffered while reading a packet from the buffer is a direct function of having a required bandwidth in excess of the capabilities provided by the memory channels that may arise, in part, from overly-aggressive scheduling on the part of the schedulers 510, 512. In other words, if the efficiency of the memory channels decreases as a result of excessive scheduling conflicts, then the effective read bandwidth available is also reduced. If the scheduler continues to schedule at a rate higher than the effective available bandwidth, then the packets may suffer an increased queuing delay.

In order to avoid the above situation, the system may implement a control loop between the read administrator 502 and the schedulers 510, 512 to throttle the scheduling rate of reads. The read administrator 502 may comprise a scheduled read counter (not shown) that keeps track of the amount of bytes that have been scheduled to be read, but have not actually been read out of the buffer 314. The scheduled read counter is incremented each time a data packet is scheduled by either the ingress scheduler 510 or the egress scheduler 512; the amount the scheduled read counter is incremented is equal to the length, in bytes, of the scheduled data packet. Each time a data page from a scheduled packet is read out of the buffer 314, the scheduled read counter is decremented by the amount of bytes in the given data page. Therefore, at any given time the read administrator 502 is aware, via the scheduled read counter, of how far behind the read subsystem is in reading scheduled packets out of the buffer 314, or the number of outstanding read bytes. In conjunction with the scheduled read counter, the read administrator 502 may maintain one or more programmable thresholds pertaining to the number of outstanding read bytes. When the scheduled read counter value exceeds a certain threshold the read administrator 502 may notify the schedulers 510, 512 and indicate that a reduction in the read scheduling rate is required.

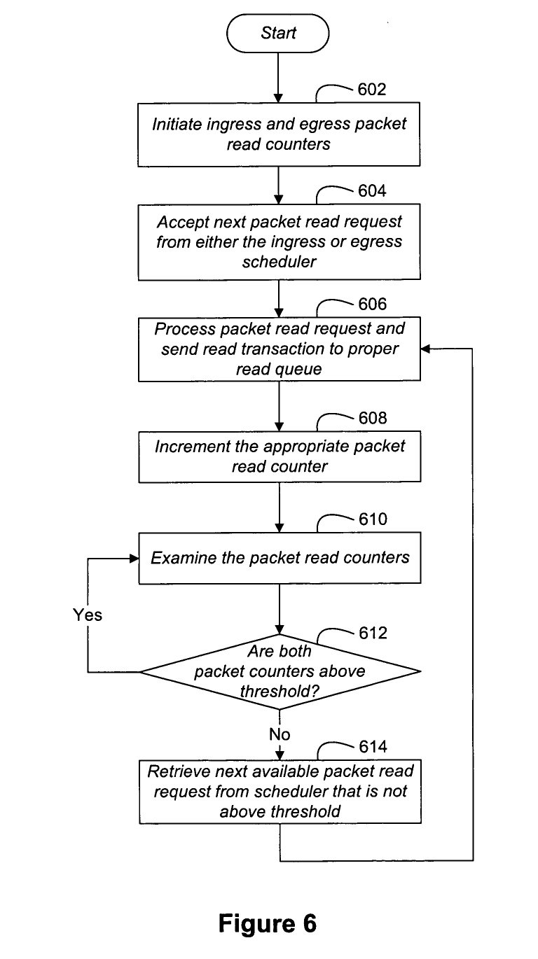

FIG. 6 illustrates a process used by the read administrator 502 when writing data pages to the DRAM buffer 118, according to one embodiment of the invention. The read administrator may first initiate the ingress and egress packet read counters to a zero or null value, indicating that there are no data packets currently being processed by the system 602. After the counters are initiated, the read administrator may then accept the next available packet read request from either the ingress or egress scheduler 604. This packet read request is then processed by the read administrator, which then sends a read transaction to the read queue of the proper memory channel 606. After sending the packet read request, the read administrator increments either the ingress or egress packet read counter, depending on where the packet read request originated 608. The read administrator then checks the packet read counters 610 and determines if either of the counters is above threshold 612. If both counters are below threshold, the read administrator simply accepts the next packet read request waiting to be serviced 614. If only one counter is below threshold, the read administrator will then only accept the next packet read request from the scheduler associated with the below-threshold counter. If both counters are at or above threshold, then the read administrator will not accept any packet read requests, but will continue to monitor the packet read counters until more packet read requests are completely processed by the system and the counters drop below the threshold value.

4. Memory Transaction Arbitration

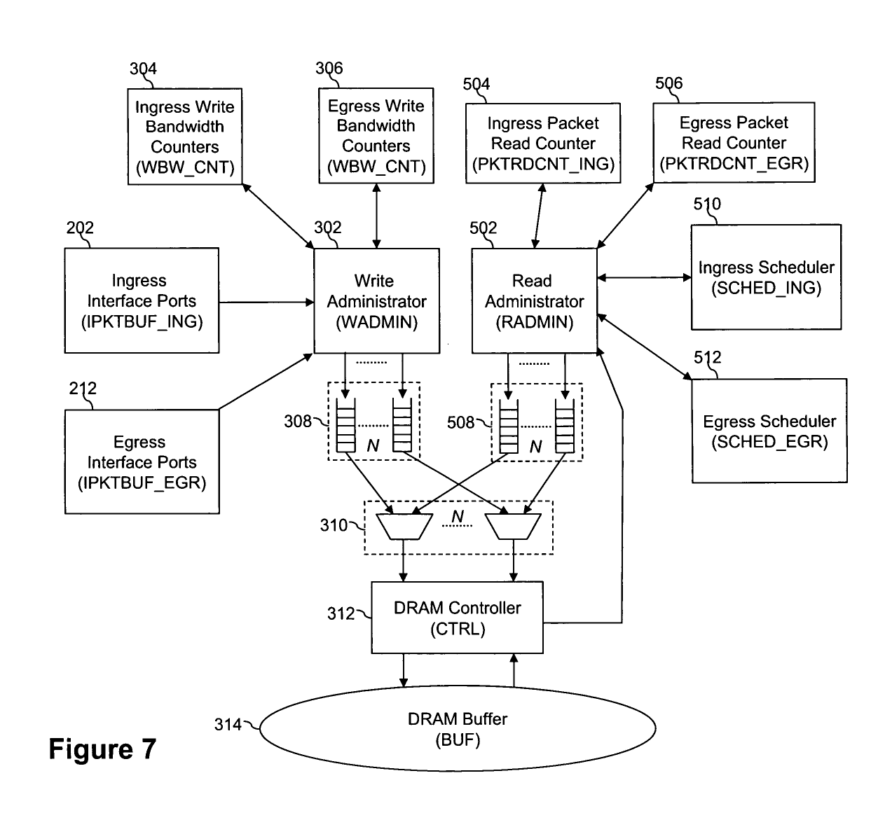

FIG. 7 shows a detailed schematic of components utilized by the packet processing system for both writing data packets to and reading data packets from an external memory 110. The memory transactions contained in the read queues 508 and the write queues 308 are moderated by an arbitration unit 310 (ARB). The arbitration unit 310 may function by scheduling read and write transactions in separate groups. This policy may help to reduce write-versus-read conflicts by generally ensuring that this type of conflict will only occur every 2*T transactions, where T is the group size utilized by the arbitration unit. The value of T may be a constant value, or it may be a dynamically configurable value that can be set by the user. In order to help optimize memory bandwidth, the value of T may be chosen to be a compromise between throughput loss and the maximum packet read latency allowed in the system. The value that best suits this compromise may be determined by estimating loss values and by conducting simulations on the DRAM controller to determine latency effects for each value. In general, the value of T may be substantially larger than one.

Using the method of creating separate transaction groups, the arbitration unit 310 may alternate between selecting entries from the read queues and the write queues. When servicing transactions in the read queues the arbitration unit may perform a round robin rotation on all of the read queues, skipping empty queues and servicing the next entry in those queues that have active requests. Alternatively, the arbitration unit may utilize a different method for determining the order in which the queues are serviced (such as servicing a single read queue until it is empty before moving on to the next queue, or servicing the next read queue that contains the next read request) as a method of prioritizing the packet that is currently being read. Once the arbitration unit has sent T read transactions to the DRAM controller, it may then switch to servicing write transactions in the write queues. Again a round robin rotation or other method may be utilized by the arbitration unit when servicing the write queues. Once T write transactions have been sent to the DRAM controller, the arbitration unit may again service the read queues and repeat the cyclical process.

In the case that all read queues or write queues become empty while being serviced, the arbitration unit 310 may utilize groups smaller than T in order to more efficiently utilize the memory bandwidth of the DRAM buffer. For example, if the arbitration has sent less than T read transactions to the DRAM controller when it is determined that all read queues 508 are currently empty, the arbitration unit may then begin servicing the write queues 308. In a similar situation where less than T write transactions have been serviced when the write queues 308 become empty, the arbitration unit may switch to servicing the read queues 508.

Additionally, the arbitration unit 310 may use different transaction grouping values for read and write transactions in order to optimize the memory bandwidth. The arbitration unit 310 may utilize a write transaction grouping value of T_{w} for write transactions and a read transaction grouping value of T_{R} for read transactions, where T_{w} and T_{R} may or may not be equal. As a result, the system or user may choose to have a write transaction grouping value that is larger than the read transaction grouping value in order to increase the throughput of write transactions that generally require less processing than read transactions.

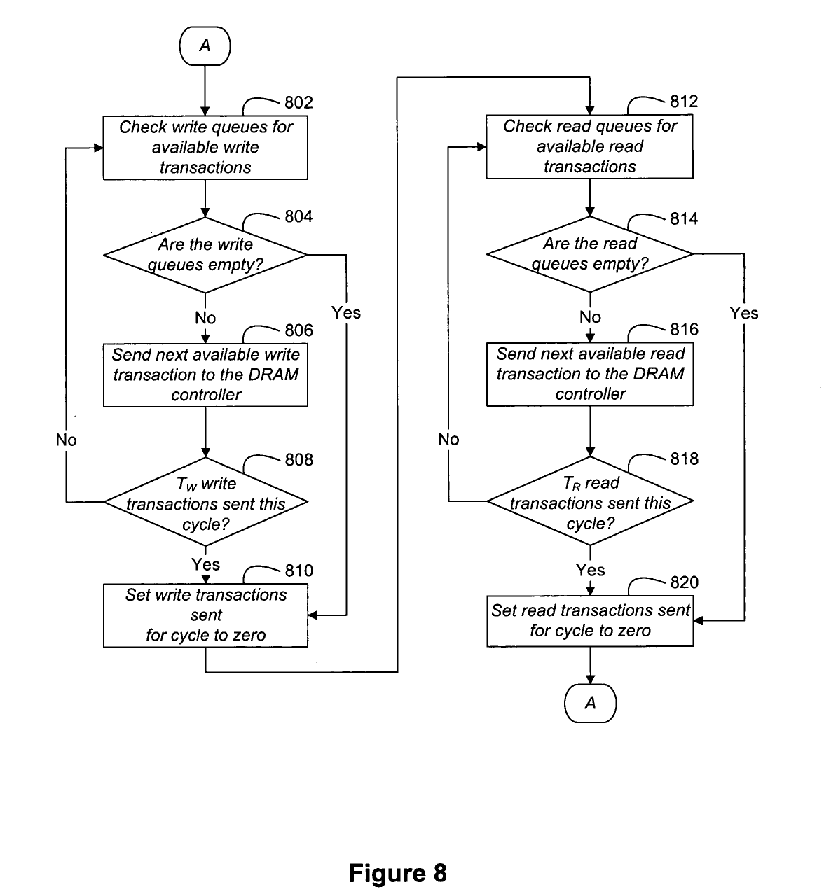

FIG. 8 illustrates the process the arbitration unit 310 may undergo in determining which transactions to the DRAM controller 312, according to one embodiment of the invention. The arbitration unit may begin by first checking the write queues 802 and determining if any write transactions are present 804. If write transactions are waiting to be serviced, the arbitration unit may then retrieve the next write transaction and send it the DRAM controller from processing 806. The arbitration unit may continue to check for available write transactions and sending them to the DRAM controller until T_{W} write transactions have been sent 808 or until all write queues are empty, at which point the arbitration unit may re-initiate the number of write transactions sent for the current arbitration cycle 810 and switch to handling red transactions. The process used to service read transactions may be similar to the one used for read transactions. Once T_{R} read transactions have been sent to the DRAM controller 818, or if the read queues become empty 814, the arbitration unit returns to the write queues and the arbitration cycle begins again. It should be noted that in a similar embodiment, the arbitration unit may alternatively begin the process by servicing the read queues first.

5. Conclusion

Exemplary embodiments of the present invention relating to a buffering system for a network device have been illustrated and described. It should be noted that more significant changes in configuration and form are also possible and intended to be within the scope of the system taught herein. For example, lines of communication shown between modules in the schematic diagrams are not intended to be limiting, and alternative lines of communication between system components may exist. In addition individual segments of information present in request and transaction packets passed between system components may be ordered differently than described, may not contain certain segments of data, may contain additional data segments, and may be sent in one or more sections.

Although the methods for buffering and read scheduling have been described with respect to a system that manages both ingress and egress data traffic, it should be understood that these methods may be equally applicable to systems that handle only ingress traffic or only egress traffic. For example, the method described above of selecting sets of non-conflicting cachelines may be utilized to increase memory efficiency in a buffering system that only receives and processes ingress traffic from an external source; likewise, a separate buffering system may be utilize this similar method for selecting sets of non-conflicting cachelines for processing egress traffic.

It should also be understood that the programs, processes, methods and apparatus described herein are not related or limited to any particular type of processor, computer, or network apparatus (hardware or software), unless indicated otherwise. Various types of general purpose or specialized processors, or computer apparatus may be used with or perform operations in accordance with the teachings described herein. While various elements of the preferred embodiments may have been described as being implemented in hardware, in other embodiments software or firmware implementations may alternatively be used, and vice-versa.

Finally, in view of the wide variety of embodiments to which the principles of the present invention can be applied, it should be understood that the illustrated embodiments are exemplary only, and should not be taken as limiting the scope and spirit of the present invention. For example, the steps of the flow diagrams may be taken in sequences other than those described, and more, fewer or other elements may be used in the block diagrams. The claims should not be read as limited to the described order or elements unless stated to that effect.

We claim:

1. A method for buffering packet data in a network device having a dynamic random access memory (DRAM) buffer, the method comprising:
receiving data packets on external ports and internal ports;
designating one or more memory channels as ingress channels, wherein the ingress channels exclusively handle data packets received on the external ports;
designating one or more memory channels as egress channels, wherein the egress channels exclusively handle data packets received on the internal ports;
paging data packets received on ingress ports into ingress data pages;
paging data packets received on egress ports into egress data pages;
writing ingress data pages to the DRAM buffer using the ingress channels; and
writing egress data pages to the DRAM buffer using the egress channels.

2. The method of claim 1 further comprising the step of requesting one or more cachelines for each of the memory channels, wherein each of the one or more cachelines comprises a set of non-conflicting addresses in the DRAM buffer.

3. The method of claim 2 further comprising the steps of:
generating an ingress write transaction for each ingress data page, wherein the ingress write transaction maps the ingress data page to the one or more addresses in the cachelines of the ingress channels; and
generating an egress write transaction for each egress data page, wherein the egress write transaction maps the egress data page to the one or more addresses in the cachelines of the egress channels.

4. The method of claim 1 further comprising the steps of:
sending the ingress write transactions to one or more ingress write queues; and
sending the egress write transactions to one or more egress write queues.

5. The method of claim 4 wherein the number of ingress write queues is substantially equal to the number of ingress channels, and wherein the number of egress write queues is substantially equal to the number of egress channels.

6. The method of claim 5 wherein each ingress write queue uniquely corresponds to an ingress channel, and wherein each egress write queue uniquely corresponds to an egress channel.

7. The method of claim 4 further comprising the step of arbitrating between ingress and egress write transactions stored in the ingress and egress write queues, and read transactions stored in a plurality of read queues.

8. The method of claim 1 further comprising the step of sending the write transactions to a DRAM controller to be serviced.

9. The method of claim 8 further comprising the step of arbitrating between write transactions and read transactions sent to the DRAM controller.

10. The method of claim 9 wherein arbitrating comprises alternating between sending multiple write transactions and multiple read transactions to the DRAM controller.

11. The method of claim 1 further comprising:
tracking the amount of data written to each memory channel using a series of write bandwidth counters; and
assigning the first data page of a data packet to the channel having the least amount of data written to it, as determined by the series of write bandwidth counters.

12. The method of claim 11 further comprising assigning subsequent data pages following the first data page to memory channels using a round-robin technique.

13. A method for buffering packet data in a network device having a dynamic random access memory (DRAM) buffer, the method comprising:
determining a read transaction grouping size and a write transaction grouping size;
monitoring one or more read queues and one or more write queues, wherein the one or more read queues exclusively hold read transactions and the one or more write queues exclusively hold write transactions;
issuing a group of write transactions to a DRAM controller, wherein the group of write transactions has a size equal to the write transaction grouping size;
issuing a group of read transactions to the DRAM controller, wherein the group of read transactions has a size equal to the read transaction grouping size; and
alternating between issuing the group of write transactions and the group of read transactions to the DRAM controller.

14. The method of claim 13 wherein the read transaction grouping size and the write transaction grouping size are substantially larger than one.

15. The method of claim 13 wherein the read transaction grouping size and the write transaction grouping sizes are dynamically modifiable.

16. A method for buffering packet data in a network device having a dynamic random access memory (DRAM) buffer, the method comprising:
selecting a current cacheline for buffering packet data comprising a first row, wherein the first row is in a first bank, and wherein the first bank is in a first device of the DRAM buffer;
selecting a new cacheline for buffering packet data comprising a second row, wherein the second row is in a second bank, wherein the second bank is in a second device of the DRAM buffer; and
wherein the new cacheline is selected according to the following criteria:
incrementing the first row to determine the second row, if the first row has been previously selected on all banks of all devices in the DRAM buffer;
incrementing the first device to determine the second device, if the first row has been previously selected on all banks of the first device; and
setting the second bank according to the value of the first bank modulus the total number of banks in each device of the DRAM buffer, if the first row has been not been previously selected on all banks of the first device.

17. The method of claim 16 wherein the second bank number is equal to the first bank number alternately incremented and decremented by a prime number greater than three modulus the total number of banks in each device of the DRAM buffer, wherein alternating between incrementing and decrementing occurs once all banks have been previously selected on a given device.

18. The method of claim 16 wherein the new device number is equal to the current device number incremented by a value of one modulus the total number of devices.

19. A system for buffering packets in a network device having a dynamic random access memory (DRAM) buffer, the system comprising:
an ingress port interface that pages data packets into ingress data pages;
an egress port interface that pages data packets into egress data pages;
a plurality of DRAM buffer channels, comprising one or more ingress memory channels that exclusively handle ingress memory transactions and one or more egress memory channels that exclusively handle egress memory transactions;
a write administrator that generates write transactions that map ingress data pages and egress data pages to physical memory locations in the DRAM buffer; and
a DRAM controller that receives and processes write transactions generated by the write administrator.

20. The system of claim 19 further comprising a plurality of write queues comprising one or more ingress write queues and one or more egress write queues, wherein each of the plurality of write queues uniquely corresponds to a memory channel, and wherein the write administrator sends ingress write transactions to the ingress write queues and egress write transactions to the egress write queues.

21. The system of claim 20 wherein the write administrator requests one or more cachelines for each ingress memory channel and egress memory channel, and wherein each cacheline comprises a series of non-conflicting addresses.

22. The system of claim 21 wherein the write administrator maps each ingress data page onto the one or more cachelines for each ingress memory channel, and maps each egress data page onto the one or more cachelines for each egress memory channel.

23. The system of claim 16 further comprising:
an ingress scheduler that generates read requests for ingress data packets to be read out of the DRAM buffer;
an egress scheduler that generates read requests for egress data packets to be read out of the DRAM buffer; and
a read administrator that processes read requests from the ingress and egress schedulers and generates read transactions for each read request.

24. The system of claim 23 further comprising:
one or more ingress packet read counters;
one or more egress packet read counters;
wherein the ingress packet read counter is incremented when an ingress data packet read request is accepted, and the egress data packet read counter is incremented when an egress data packet read request is accepted;
wherein the ingress packet read counter is decremented when an ingress data packet is read out of the DRAM buffer, and the egress data packet read counter is decremented when an egress data packet is read out of the DRAM buffer; and
wherein the read administrator ceases accepting ingress packet read requests when the ingress packet read counter exceeds a first threshold, and the read administrator ceases accepting egress data packet read requests when the egress packet read counter exceeds a second threshold.

25. The system of claim 24 further comprising a plurality of read queues comprising one or more ingress read queues and one or more egress read queues, wherein each of the plurality of read queues uniquely corresponds to a memory channel, and wherein the read administrator sends ingress read transactions to the ingress read queues and egress read transactions to the egress read queues.

26. The system of claim 25 further comprising an arbitrator that alternates between sending groups of read transactions and groups of write transactions to the DRAM controller.

27. The system of claim 19 further comprising:
a scheduled read counter;
wherein the scheduled read counter is incremented by the number of bytes in a data packet when the data packet is scheduled to be read;
wherein the scheduled read counter is decremented by the number of bytes in a data page when the data page is read from the DRAM memory; and
wherein the read administrator prompts the ingress scheduler and the egress scheduler to reduce the rate of read request issues if the scheduled read counter exceeds a programmable threshold.

28. The system of claim 19 wherein the one or more ingress memory channels and the one or more egress memory channels are dynamically selected by the write administrator based on packet data traffic on the ingress and egress ports interface.

29. A system for buffering packets in a network device having a dynamic random access memory (DRAM) buffer, the system comprising:
a port interface that pages data packets into data pages;
a plurality of DRAM buffer channels;
a write administrator that generates write transactions that map data pages to physical memory locations in the DRAM buffer;
a scheduler that generates read requests for data packets to be read out of the DRAM buffer;
a read administrator that processes read requests from the scheduler and generates read transactions for each read request;
a DRAM controller that receives and processes write transactions generated by the write administrator and read transactions generated by the read administrator; and
wherein the write administrator requests one or more cachelines for each ingress memory channel and egress memory channel, and wherein each cacheline comprises a series of non-conflicting addresses.

30. The system of claim 29 further comprising one or more packet read counters, wherein the packet read counters are incremented when a data packet read request is accepted; wherein the packet read counter is decremented when a data packet is read out of the DRAM buffer; and wherein the read administrator ceases accepting packet read requests when the ingress packet read counter exceeds a threshold.

31. The system of claim 29 further comprising an arbitrator that alternates between sending groups of read transactions and groups of write transactions to the DRAM controller.

32. The system of claim 29 further comprising:
a scheduled read counter;
wherein the scheduled read counter is incremented by the number of bytes in a data packet when the data packet is scheduled to be read;
wherein the scheduled read counter is decremented by the number of bytes in a data page when the data page is read from the DRAM memory; and
wherein the read administrator prompts the scheduler to reduce the rate of read request issues if the scheduled read counter exceeds a programmable threshold.
